(19) United States
(12) Patent Application Publication
(10) Pub. No.: US 2026/0217505 A1
(43) Pub. Date: Jul. 30, 2026

(54) METHOD FOR CONTROLLING THE POSITIONING OF AN AUTONOMOUS FORKLIFT RELATIVE TO AN ANNULAR LOAD TO BE LIFTED

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); GUILLAUME GOUTTE, Clermont-Ferrand (FR); AMAURY PELLISSIER DE FELIGONDE, Clermont-Ferrand (FR); MELANIE BERNARD, Clermont-Ferrand (FR)

(21) Appl. No.: 19/137,575

(22) PCT Filed: Dec. 4, 2023
(86) PCT No.: PCT/FR2023/051917

§ 371 Date: Jun. 10, 2025

(30) Foreign Application Priority Data
Dec. 14, 2022 (FR) 2213357

(51) Int. Cl. B66F 9/06; B66F 9/075; G06T 7/73

(52) U.S. Cl. CPC B66F 9/063; B66F 9/0755; G06T 7/73; G06T 2207/10028

(57) ABSTRACT

A method for controlling the positioning of an autonomous forklift relative to an annular load to be lifted comprises: acquiring at least one image of the annular load by means of at least one 3D camera fastened to the forklift; digitally processing the image obtained, comprising: detecting at least one circle corresponding to the inner diameter or the outer diameter of the annular load, calculating a centering error of the forklift relative to the annular load, determining a plane corresponding to the front face of the annular load, and calculating an angle error of the forklift relative to the annular load; and stopping the forklift if at least one of the calculated angle error or centering error values is greater, as an absolute value, than a predefined limit value.

### TECHNICAL FIELD

The present invention relates to the field of autonomous vehicles for the automated transportation of loads, such as autonomous forklifts.

### PRIOR ART

Autonomous vehicles for transporting loads are increasingly being used to increase productivity and improve logistics management in factories or in warehouses.

Automated forklifts are one example of such vehicles and make it possible for example for a load to be loaded, transported and positioned at height without human intervention.

However, in environments such as factories or warehouses, human intervention is still required in addition to the automated operations, for example to control the satisfactory progress of these operations or to perform tasks that cannot be carried out by machines alone. These environments are therefore shared between humans and autonomous machines.

Personal safety is of fundamental importance in such working environments and accordingly requires that specific procedures be put in place.

For example, during operations to pick a load from storage shelving, the position of the forklift relative to the load must in particular be controlled.

If the positioning of the forklift relative to the load is incorrect, there is a risk that the load will tip when it is picked, and therefore the risk of an accident.

### DISCLOSURE OF THE INVENTION

In light of the above, the aim of the invention is to increase the safety of load picking operations by a forklift.

The invention relates to a method for controlling the positioning of an autonomous forklift relative to an annular load to be lifted and transported, said forklift comprising a vertically movable fork provided with at least one arm.

The method comprises a step of acquiring at least one image of the annular load by means of at least one 3D camera rendering a point cloud of coordinates measured in a coordinate system associated with said 3D camera, said 3D camera being fastened to the autonomous forklift centred relative to the fork and having a line of sight oriented forwards along a longitudinal axis of said forklift.

The method further comprises a step of digitally processing said image obtained in the acquisition step, comprising a sub-step of detecting at least one circle located on a front face of the annular load and corresponding to the inner diameter or the outer diameter of the annular load, and a sub-step of calculating an offset, in a plane perpendicular to the line of sight, between the centre of said detected circle and the centre of said 3D camera, said offset representing a centring error of the forklift relative to the annular load.

The method also comprises a sub-step of determining a plane corresponding to the front face of the annular load, and a sub-step of calculating the angle between the normal to said determined plane and the line of sight of said 3D camera, said angle representing an angle error of the forklift relative to the annular load.

The method further comprises a step of stopping the forklift if at least one of the calculated angle error or centring error values is greater, as an absolute value, than a predefined limit value.

“Front face” of the annular load is given to mean the frontal face of the load that is oriented on the same side as the camera.

Such a method makes it possible to determine the relative position between the load and the forklift and to increase the safety of operations by stopping the forklift if at least one centring error or angle error value exceeds a predefined limit value.

Advantageously, the digital processing step can further comprise sub-steps of calculating the depth and the outer diameter of the annular load, said step of stopping the forklift being carried out if the calculated values of the depth and the outer diameter of the annular load do not correspond to predefined values.

The load is picked by the forklift only if the depth and outer diameter measurements correspond to predefined values, thus making it possible to ensure that the load in front of the forklift matches the load to be picked, and therefore further increase the safety of operations.

In one embodiment, the method further comprises a prior step of the forklift receiving an assigned mission comprising the predefined values of the depth and the outer diameter of the annular load to be transported.

According to one feature, the depth of the annular load is calculated on the basis of the inner circle corresponding to the inner diameter of said annular load and having a diameter D₁₆, an inner circle located on a rear face of the annular load and corresponding to an inner surface of said annular load and having a diameter D₁₇, and the distance d between said 3D camera and the front face of the load, using the following equation:

$$P = d \times \frac{{D}_{16} - {D}_{17}}{{D}_{17}} \qquad ( Eq . 1 )$$

“Rear face” of the annular load is given to mean the frontal face of the load that is oriented on the opposite side from the camera. The front and rear faces define the thickness of the load.

According to another feature, the depth of the annular load is equal to the maximum difference between the coordinates of the points of an inner surface of the annular load between the inner circle corresponding to the inner diameter of said annular load and having a diameter D₁₆, and an inner circle located on a rear face of the annular load and corresponding to an inner surface of said annular load and having a diameter D₁₇, said difference being measured along the axis of the coordinate system oriented along the line of sight of said 3D camera.

Advantageously, the acquisition step can comprise the following successive sub-steps: a first sub-step of acquiring at least one image, a sub-step of advancing the forklift towards the annular load by a predefined distance, and a second sub-step of acquiring at least one image carried out when the forklift has covered said predefined distance.

For example, the sub-steps of calculating the centring error and the angle error of the forklift relative to the annular load are carried out after the first acquisition sub-step, and the sub-steps of calculating the depth and outer diameter of the annular load are carried out after the second acquisition sub-step.

For example, the detection sub-step comprises detecting the inner circle corresponding to the inner diameter of said load, and detecting the outer circle corresponding to the outer diameter of the annular load.

Advantageously, the digital processing step comprises a sub-step of filtering the images obtained in the acquisition step. This filtering sub-step is carried out before the other sub-steps of the digital processing step and makes it possible to reduce the amount of data to be processed by filtering the points of the images obtained in the acquisition step in order to keep only the points that form part of a region of particular interest. By limiting the calculations to the reduced areas of the region of particular interest, the method obtains results more quickly without adversely affecting the quality thereof. By limiting the data to the regions of interest, the size of the memory required for the command and digital image processing module associated with the 3D cameras is also reduced.

According to one advantageous feature, the image acquisition step comprises a prior sub-step of calculating an optimum gain of said 3D camera used for image acquisition.

In one particular embodiment, the step of acquiring at least one image of the load is carried out by a single 3D camera. As a variant, the acquisition step can be carried out by a plurality of 3D cameras.

According to another aspect, the invention relates to an autonomous forklift comprising a vertically movable fork provided with at least one arm, at least one 3D camera for acquiring at least one point cloud data image, said 3D camera being fastened to the autonomous forklift centred relative to the fork and having a line of sight oriented forwards along a longitudinal axis of said forklift, a command and digital image processing module associated with the 3D camera, a wireless telecommunication device, and a unit for controlling said forklift configured to implement a method as described above.

Preferably, the line of sight of said 3D camera is horizontal and parallel to the longitudinal axis of said arm of the fork.

Preferably, the line of sight of said 3D camera is situated at a distance of less than 100 mm from a horizontal plane containing said arm of the fork.

### BRIEF DESCRIPTION OF THE FIGURES

Further aims, features and advantages of the invention will become apparent on reading the following description, which is given solely by way of non-limiting example, and with reference to the appended drawings, in which:

FIG. 1 is a perspective view of an autonomous forklift according to one exemplary embodiment of the invention;

FIG. 2 is a detailed view of the forklift in FIG. 1;

FIG. 3 schematically illustrates the forklift in FIG. 1, while it is in use;

FIG. 4 is a simplified example of an image acquired by a camera of the forklift in FIG. 1; and

FIG. 5 illustrates the flow diagram for a method for controlling the relative positioning of a forklift and a load according to one embodiment of the invention.

### DETAILED DESCRIPTION OF AT LEAST ONE EMBODIMENT

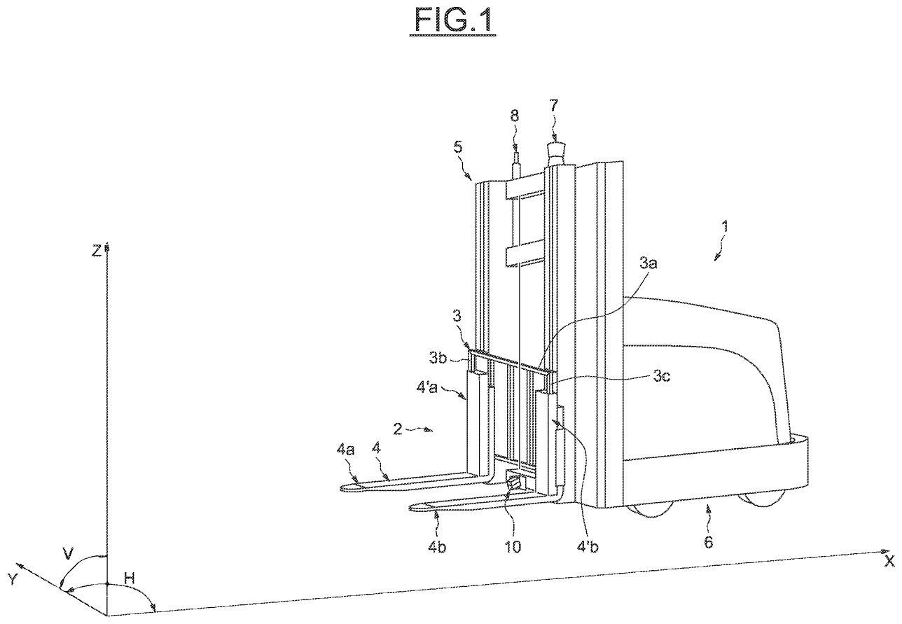

FIG. 1 depicts the main elements of an autonomous forklift 1 according to one embodiment of the invention.

The architecture of the forklift 1 is given by way of example and does not limit the invention to the architectural configuration depicted alone. It will be understood that the invention also relates to forklifts designed to operate in manual mode and which have been adapted to enable a second autonomous operating mode.

The autonomous forklift 1 illustrated in FIG. 1 comprises a lifting member 2 comprising a carriage 3 that bears a fork 4 comprising two arms 4a, 4b that are spaced apart laterally and extend towards the front of the forklift. As a variant, the fork 4 could comprise just one arm.

The carriage 3 forms a frame. The carriage 3 is provided with a horizontal upper crossmember 3a, and two arms 3b, 3c extending the upper crossmember 3a vertically downwards.

The fork 4 also comprises two uprights 4′a, 4′b, which are fastened to the carriage 3 and each bear one of the arms 4a, 4b. Each of uprights 4′a, 4′b is fastened to one of the arms 3b, 3c of the carriage.

The arms 4a, 4b of the fork are generally used for insertion into entry openings provided in the transport pallets bearing the loads to be lifted. The uprights 4′a, 4′b allow the arms 4a, 4b to be raised so that a pallet to be transported or another type of load can be lifted and so that a pallet or another type of load can be positioned or collected at height.

The fork 4 can move in translation in a vertical plane V defined by the carriage 3, along a vertical mast 5 of the forklift. The uprights 4′a, 4′b can slide along the mast 5. The arms 4a, 4b of the fork can move between an uppermost position and a lowermost position that is illustrated in FIG. 1 and that corresponds to a running position. In the lowermost position, the arms 4a, 4b are situated at a distance from the ground.

The longitudinal axes of the arms 4a, 4b are parallel. These longitudinal axes are oriented parallel to a horizontal axis X and define a horizontal plane H referred to as the lifting plane. The arms 4a, 4b of the fork 4 are perpendicular to the vertical plane V. The arms 4a, 4b of the fork 4 can preferably also move laterally relative to each other.

As a variant, the arms 4a, 4b could also be telescopic or retractable and/or able to be oriented angularly about their longitudinal axis.

As is known per se, the forklift 1 is provided with a drive system 6 enabling the forklift 1 to move. The drive system comprises at least one electric motor or combustion engine (not shown) providing drive to the wheels of the forklift 1.

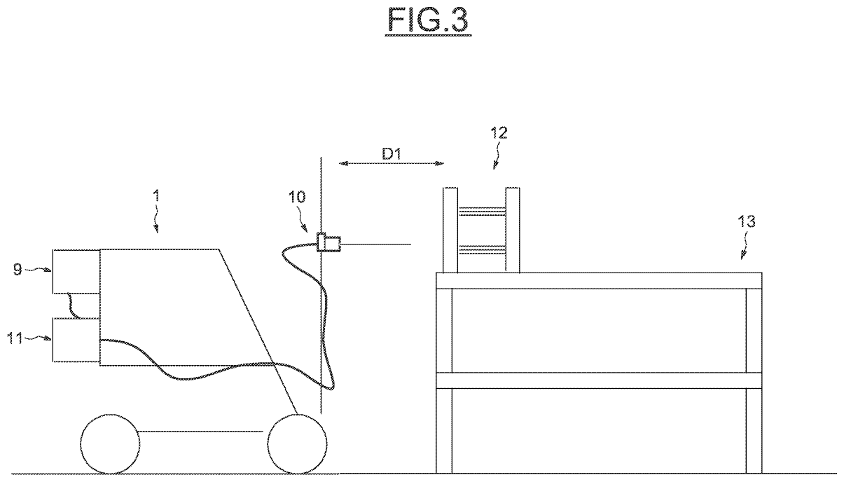

The forklift 1 is also provided with an on-board locator device 7, an on-board wireless telecommunication device 8 and an on-board control unit 9 (FIG. 3) receiving information from the locator device 7 and from the wireless telecommunication device 8 in order to autonomously command the movement of the forklift.

The forklift 1 is also provided with at least one 3D camera 10 for measuring time of flight (TOF), and an associated command and digital image processing module 11 (FIG. 3), referred to as the vision module, which commands the capturing of images by the 3D camera and receives and interprets the images captured by the 3D camera. In the remainder of the description, the module 11 will be referred to as the vision module.

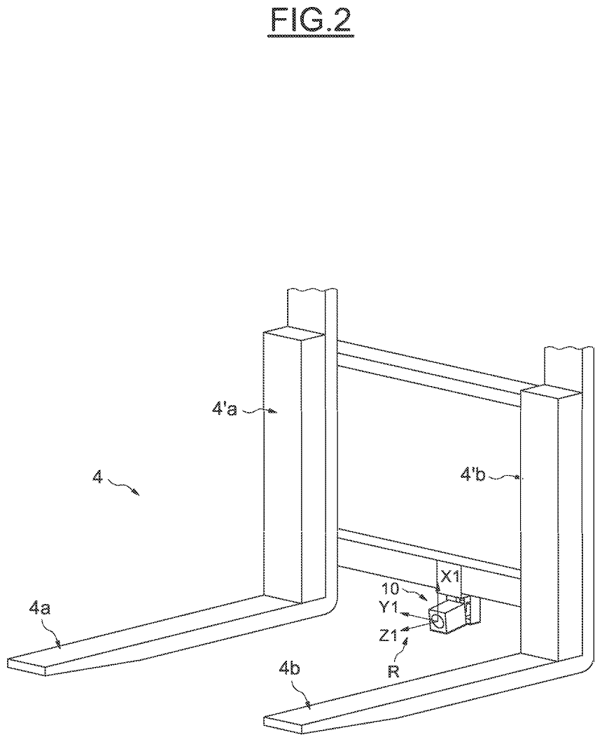

As is known per se, the 3D camera 10 is able to capture an image of an object and render a point cloud of relative coordinates measured with respect to a frame of reference associated with the 3D camera. The frame of reference associated with the 3D camera 10 comprises a coordinate system R made up of three orthogonal axes X1, Y1, Z1, as illustrated in FIG. 2. Here, the axis Z1 of the coordinate system is oriented along the line of sight of the 3D camera 10, and the axis Y1 of the coordinate system is oriented along a horizontal axis Y perpendicular to the line of sight of the 3D camera 10. A 3D camera is able to measure distances along all three axes of the coordinate system associated therewith. For example, as illustrated, the horizontal, vertical or depth offset relative to the 3D camera 10 is measured along the axes Y1, X1 or Z1 respectively.

The 3D camera 10 is separate from the locator device 7. Here, the 3D camera 10 is separate from the vision module 11. Alternatively, the 3D camera 10 and the vision module 11 could form a single assembly.

The control unit 9 comprises the hardware and software for commanding the operation of the drive system 6 on the basis of the information received from the locator device 7 and the telecommunication device 8.

The control unit 9 also commands the operation of the drive system 6 on the basis of the data from the vision module 11 and is configured to communicate therewith. Alternatively, the vision module 11 could be integrated into the control unit 9. The control unit 9 also makes it possible to command the autonomous movement of the lifting member 2.

As illustrated in FIGS. 1 and 2, the 3D camera 10 is centred relative to the fork 4 and its line of sight is oriented forwards along a longitudinal axis of the forklift 1. Preferably, the line of sight of the 3D camera 10 is horizontal and parallel to the lifting plane H.

The 3D camera 10 is fastened to the carriage 3 at a constant height relative to the lifting plane H and without any possibility of moving relative to said carriage. The 3D camera 10 is able to move conjointly with the fork 4. Here, the 3D camera 10 is fastened to the lower part of the carriage 3 above the lifting plane H. In some variants (not shown), the 3D camera 10 can be fastened to the carriage 3 level with the lifting plane H or below said plane. Preferably, the line of sight of the 3D camera 10 is situated at a relative distance of less than 100 mm from the plane formed by the arms of the fork, that is the lifting plane H.

As described in greater detail below, the 3D camera 10 is able to capture images of the environment in front of the forklift 1, in order to determine the actual position of the loads to be lifted and transported by the forklift.

The wireless telecommunication device 8 is configured to communicate with the control unit 9 and with a computerized warehouse management system (WMS) (not shown) that is remote from the forklift 1 and intended to manage the operations of a storage warehouse and command a fleet of forklifts 1.

Each forklift 1 receives information in the form of periodic electronic messages sent by the WMS regarding missions that are assigned to it relating to journeys to be made and/or loads to be transported. Each forklift 1 is capable of sending the WMS electronic messages representing the status of the missions assigned to it. A forklift 1 can for example report an error encountered during the performance of a mission by sending an error code.

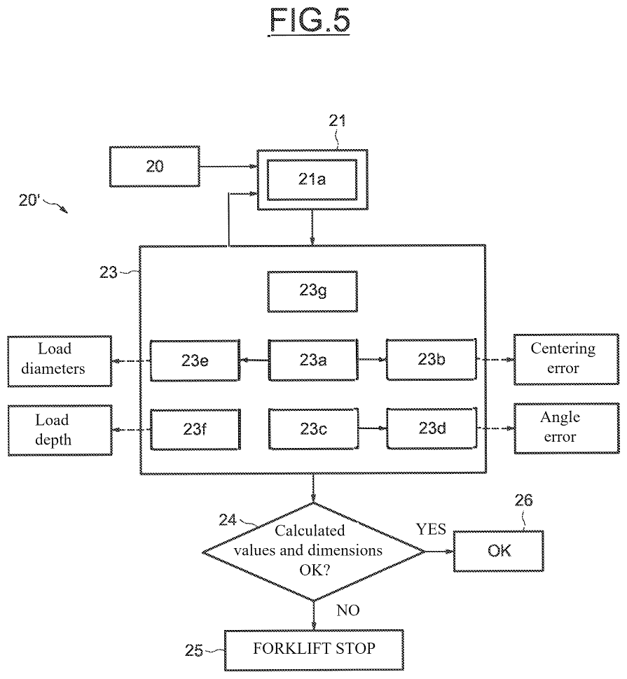

The operating principle of the autonomous forklift 1 for the operation of picking an annular load 12 situated on a shelving structure 13 and the method 20′ for controlling the relative positioning between the forklift and the load 12 illustrated in FIG. 5 will now be described with reference to FIGS. 3 to 5. An annular load 12 generally comprises a support consisting of a hollow cylindrical core, generally provided with solid or spoked circular flanges, intended to receive a payload that is wound around the core. The payload can for example comprise a wire, a cable, a fabric or a rubber strip, etc. Alternatively, the annular load 12 can be a tyre.

The method 20′ starts with a prior receiving step 20 in which the wireless telecommunication device 8 of the forklift receives an instruction relating to an annular load to be transported, constituting a mission assigned to the forklift by the WMS. The instruction comprises information relating to the type of load to be transported, the dimensions of the load, the current position of the load and the destination thereof. Particularly with regard to the dimensions of the load, the instruction comprises the values of the depth of the inner surface and the outer diameter of the load.

In one variant embodiment, the instruction relating to an annular load to be transported can be predefined and contained in a memory of the forklift 1. The values of the depth of the inner surface and outer diameter of the load can particularly be predefined and contained in a memory of the forklift 1.

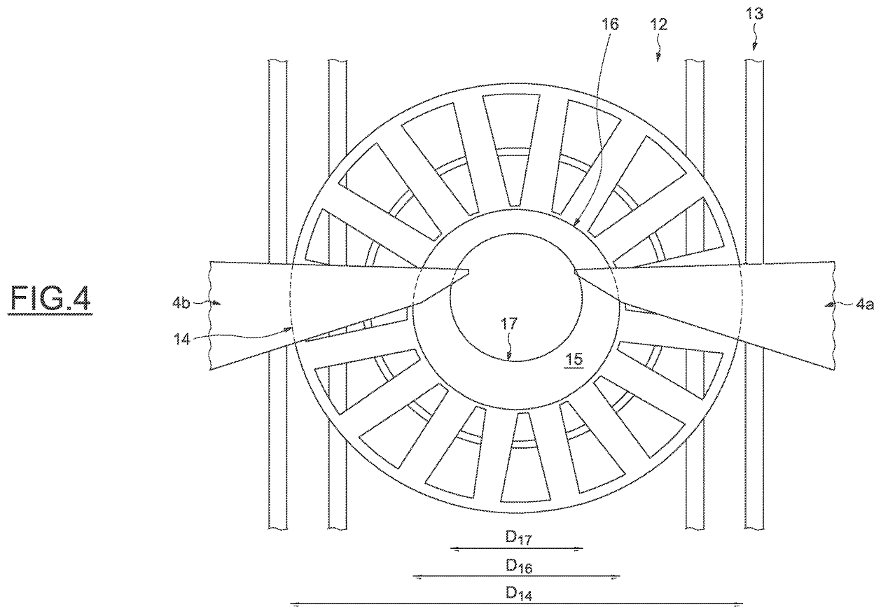

The method 20′ continues with a step 21 of acquiring at least one image of the annular load by means of the 3D camera 10, which is commanded by the vision module 11. The image is acquired at a predefined distance D1 (FIG. 3) from the load 12. When the forklift is situated at this predefined distance D1, the control unit 9 stops the forklift 1 and sends an image acquisition request to the vision module 11, which commands the capturing of images by the associated 3D camera 10. The 3D camera 10 thus captures at least one image of the load 12 situated in front of the forklift 1 and sends it to the vision module 11. A simplified example of a captured image is illustrated in FIG. 4. The images captured by the 3D camera 10 render a point cloud of coordinates X1, Y1, Z1 in the coordinate system R associated with the 3D camera 10.

Preferably, the acquisition step 21 comprises a prior sub-step 21a of calculating an optimum gain of the 3D camera used for image acquisition. The gain is considered to be optimum when the brightness values of an image are evenly distributed over the entire dynamic range of the image sensor. The dynamic range of a sensor is equal to the difference between the highest light levels and the lowest light levels that can be detected by the sensor.

In order to spread the brightness values over the entire dynamic range and to avoid outliers, the optimum gain is obtained on the basis of the maximum value of the dynamic range of the image sensor of the 3D camera and the brightness values of an image previously acquired in the given working conditions and with a unity gain, and on the basis of the ratio between the maximum value of the dynamic range and the brightness value that corresponds to the ninth decile of said image.

After the acquisition step 21, the method continues with a step 23 of digitally processing the images obtained, carried out by the vision module 11. It should be noted that the digital processing of the images can start as soon as the image captured by the 3D camera 10 is made available to the vision module 11.

The digital processing step comprises a sub-step 23a of detecting circles 14, 16 located on a front face of the load 12, illustrated in FIG. 4, and a circle 17 located on a rear face of the load 12.

The circles are detected such that the circle 14 is the circle that is observed on the front face of the load and corresponds to the outer surface of the load 12, and the circles 16, 17 are respectively the circles that are observed on the front face and the rear face thereof and correspond to the inner surface of the load 12. The circles 14, 16 and 17 are detected using known circle detection methods, for example the Hough transform method.

The sub-step of detecting inner circles 14, 16 and outer circle 17 is followed by a sub-step 23b of calculating an offset measured in a plane perpendicular to the line of sight (i.e. along the axes X1 and Y1 of the coordinate system R in FIG. 2), between the centre of one of the inner circles 14, 16 detected and the centre of the 3D camera 10 represented by the origin of the coordinate system R. This offset represents the centring error of the carriage 1 relative to the load 12.

The outer and inner diameters of the load 12 are determined in a sub-step 23e. In this step, these outer and inner diameters are considered to be equal to the diameters D₁₄, D₁₆ (FIG. 4) of the outer circle 14 and inner circle 16 that are observed on the front face of the load. During this sub-step 23e, the diameter D₁₇ of the inner circle 17 is also determined. The value of the diameter D₁₇ is less than the value of the diameter D₁₆ due to the vanishing angle of the image.

The digital processing step 23 also comprises a sub-step 23c of determining a plane that corresponds to the front face of the load 12. This process can for example be carried out using an iterative method based on a RANSAC (random sample consensus) algorithm that eliminates outliers.

This sub-step 23c is followed by a sub-step 23d of calculating the angle between the normal to the plane determined and the line of sight of the 3D camera 10. This angle represents the angle error of the carriage relative to the load.

The digital processing step 23 also comprises a sub-step 23f of calculating the depth P of the annular load 12.

In one embodiment, the depth P is calculated on the basis of the diameter values D₁₆ and D₁₇ of the circles 16, 17 determined in sub-step 23e, and the value of the distance d between the front face of the load 12 and the 3D camera 10 that is determined thereby, by applying the following equation:

$$P = d \times \frac{{D}_{16} - {D}_{17}}{{D}_{17}} \qquad ( Eq . 1 )$$

Alternatively, in another embodiment, for example when the contrast between the front and rear faces of the load 12 is insufficient, the depth P of the load is calculated as being equal to the maximum difference between the coordinates of the points of the inner surface 15 of the annular load 12, measured along the axis of the coordinate system R oriented along the line of sight of the 3D camera 10.

After the digital processing step 23, the method continues with a step 24 of comparing the values calculated during sub-steps 23b, 23d to predefined values sent by the WMS in step 20 or stored in the memory of the forklift.

During the comparison step 24, if the calculated value of the centring error of the forklift relative to the load is greater, as an absolute value, than a predefined associated limit value, the control unit 9 commands the forklift 1 to stop for correction by an operator (step 25).

Similarly, if the calculated value of the angle error of the forklift relative to the load is greater, as an absolute value, than a predefined associated limit value, the control unit 9 commands the forklift 1 to stop for correction by the operator (step 25).

These two limit values can be determined according to the permissible tolerances of the centring errors and angle errors relative to the safety requirements for lifting and transport operations.

During step 24, the values calculated during sub-steps 23e, 23f are also compared to the dimensions of the load received in step 20 or stored in the memory of the forklift. If the calculated value of the outer diameter D₁₄ of the load is greater than the predefined outer diameter value received, the control unit 9 commands the forklift 1 to stop for correction by the operator (step 25).

Similarly, if the calculated value of the depth of the load is greater than the predefined depth value received in step 20 or stored in the memory of the forklift, the control unit 9 commands the forklift 1 to stop for correction by the operator (step 25).

During step 25 of stopping the forklift, the control unit 9 can send the WMS an error message representing the error encountered.

Conversely, if the calculated values correspond to the associated predefined values, the control unit of the forklift controls the lifting and transport operation (step 26).

In the exemplary embodiment described above, the step 21 of acquiring one or more images is carried out at the distance D1 from the load 12 only. Alternatively, the acquisition step 21 can comprise a first sub-step of acquisition at the distance D1, followed by a second sub-step of acquisition at a shorter distance D2 from the load, which therefore occurs after the forklift has advanced.

This two-stage acquisition can be beneficial for loads with large dimensions, for which the viewing angle of the 3D camera 10 might be too small to capture both the inner surface and the outer surface of the load. In this case, the first acquisition sub-step is carried out so that the outer diameter of the load can be calculated, and the second acquisition sub-step is carried out so that the inner diameter and the depth of the inner surface of the load 12 can be calculated.

In this case, the sub-steps 23b, 23d of calculating the centring error and the angle error of the forklift relative to the annular load can be carried out after the first acquisition sub-step, and the sub-steps 23f, 23e of calculating the depth and outer diameter of the annular load can be carried out after the second acquisition sub-step. Alternatively, it could be possible to carry out sub-steps 23b to 23f after the second acquisition sub-step.

In the exemplary embodiments described, the sub-steps 23f, 23e of calculating the depth and outer diameter of the annular load are provided in order to increase the safety of operations. As a variant, these steps could be omitted. In this case, in the detection sub-step 23a, only one of the circles 14 or 16 can be detected.

In the exemplary embodiment illustrated, the digital processing step 23 comprises a prior additional sub-step 23g of filtering points. This sub-step 23g is carried out before the other sub-steps of the digital processing step 23 and makes it possible to reduce the amount of data to be processed by filtering the points of the images obtained in the acquisition step in order to keep only the points that form part of a region of particular interest. For example, the inner surface 15 of the load 12 can constitute a region of particular interest. By limiting the calculations to the reduced areas of the region of particular interest, the method obtains results more quickly without adversely affecting the quality thereof. By limiting the data to the regions of interest, the size of the memory required for the vision module 11 is also reduced. Alternatively, this filtering sub-step 23g could be omitted.

1.-14. (canceled)

15. A method for controlling positioning of an autonomous forklift relative to an annular load to be lifted and transported, the forklift comprising a vertically movable fork provided with at least one arm, and the method comprising:
a step of acquiring at least one image of the annular load by means of at least one 3D camera rendering a point cloud of coordinates measured in a coordinate system associated with the 3D camera, the 3D camera being fastened to the autonomous forklift centered relative to the vertically movable fork and having a line of sight oriented forward along a longitudinal axis of the forklift;
a step of digitally processing the image obtained in the acquisition step comprising:
a sub-step of detecting at least one circle located on a front face of the annular load and corresponding to an outer diameter or inner diameter of the annular load,
a sub-step of calculating an offset, in a plane perpendicular to the line of sight, between the center of the detected circle and a center of the 3D camera, the offset representing a centering error of the forklift relative to the annular load,
a sub-step of determining a plane corresponding to the front face of the annular load, and
a sub-step of calculating an angle between a normal to the determined plane and the line of sight of the 3D camera, the angle representing an angle error of the forklift relative to the annular load; and
a step of stopping the forklift if at least one of the calculated angle error or centering error values is greater, as an absolute value, than a predefined limit value.

16. The method according to claim 15, wherein the digital processing step further comprises sub-steps of calculating a depth P and the outer diameter of the annular load, the step of stopping the forklift being carried out if the calculated vales of the depth and the outer diameter of the annular load do not correspond to predefined values.

17. The method according to claim 16, further comprising a prior step of the forklift receiving an assigned mission comprising the predefined values of the depth and the outer diameter of the annular load to be transported.

18. The method according to claim 16, wherein the depth P of the annular load is calculated on a basis of an inner circle corresponding to the inner diameter of the annular load and having a diameter D16, an inner circle located on a rear face of the annular load and corresponding to an inner surface of the annular load and having a diameter D17, and a distance d between the 3D camera and the front face of the load, using the following equation:
$$P = d \times \frac{{D}_{16} - {D}_{17}}{{D}_{17}} . \qquad ( Eq . 1 )$$

19. The method according to claim 16, wherein the depth P of the annular load is equal to a maximum difference between the coordinates of the points of an inner surface of the annular load between an inner circle corresponding to the inner diameter of the annular load and having a diameter D16, and an inner circle located on a rear face of the annular load and corresponding to an inner surface of the annular load and having a diameter D17, the difference being measured along an axis of the coordinate system oriented along a line of sight of the 3D camera.

20. The method according to claim 15, wherein the acquisition step comprises the following successive sub-steps:
a first sub-step of acquiring at least one image;
a sub-step of advancing the forklift toward the annular load by a predefined distance; and
a second sub-step of acquiring at least one image carried out when the forklift has covered the predefined distance.

21. The method according to claim 20, wherein the digital processing step further comprises sub-steps of calculating a depth P and the outer diameter of the annular load, the step of stopping the forklift being carried out if the calculated vales of the depth and the outer diameter of the annular load do not correspond to predefined values, and
wherein the sub-steps of calculating the centering error and the angle error of the forklift relative to the annular load are carried out after the first acquisition sub-step, and the sub-steps of calculating the depth P and outer diameter of the annular load are carried out after the second acquisition sub-step.

22. The method according to claim 15, wherein the detection sub-step comprises detecting an inner circle corresponding to the inner diameter of the load and detecting an outer circle corresponding to the outer diameter of the annular load.

23. The method according to claim 15, wherein the digital processing step comprises a sub-step of filtering the image obtained in the acquisition step that is carried out before the other sub-steps of the digital processing step.

24. The method according to claim 15, wherein the image acquisition step comprises a prior sub-step of calculating an optimum gain of the 3D camera used for image acquisition.

25. The method according to claim 15, wherein the step of acquiring the image of the annular load is carried out by a single 3D camera.

26. The autonomous forklift comprising the vertically movable fork provided with the at least one arm, the at least one 3D camera for acquiring at least one point cloud data image, the 3D camera being fastened to the autonomous forklift centered relative to the fork and having a line of sight oriented forward along a longitudinal axis of the forklift, a command and digital image processing module associated with the 3D camera, a wireless telecommunication device, and a unit for controlling the forklift configured to implement the method according to claim 15.

27. The autonomous forklift according to claim 26, wherein the line of sight of the 3D camera is horizontal and parallel to the longitudinal axis of the arm of the vertically movable fork.

28. The autonomous forklift according to claim 26, wherein the line of sight of the 3D camera is situated at a distance of less than 100 mm from a horizontal plane containing the arm of the vertically movable fork.
